(19) United States
(12) Patent Application Publication
(10) Pub. No.: US 2014/0293290 A1
(43) Pub. Date: Oct. 2, 2014

(54) Method and System for Compact Optical Coherence Tomography

(71) Applicant: MANISH KULKARNI, Pleasanton, CA (US)

(72) Inventor: MANISH KULKARNI, Pleasanton, CA (US)

(73) Assignee: NETRA SYSTEMS INC., PLEASANTON, CA (US)

(21) Appl. No.: 14/302,366

(22) Filed: Jun. 11, 2014

Related U.S. Application Data
(63) Continuation-in-part of application No. 12/941,991, filed on Nov. 8, 2010, now Pat. No. 8,797,551.
Application No. 12/941,991 is a continuation-in-part of application No. 13/723,006, filed on Dec. 20, 2012.

(51) Int. Cl. G01B 9/02

(52) U.S. Cl. CPC G01B 9/02015; G01B 9/02091
USPC 356/479

(57) ABSTRACT

The tunable filter placed in front of the detector to make the interferometer more sensitive and accurate for reading various samples for diagnosis. Optical Coherence Tomography (OCT) system and apparatus of this instant application is very useful for diagnosis and management of ophthalmic diseases such as retinal diseases and glaucoma etc. Instant innovative OCT diagnostic system leverages advancements in cross technological platforms. Both the Michelson interferometric system and Mach-Zehnder interferometric system presented in this application could be used for the OCT imaging, which includes biological OCT imaging, medical OCT imaging, ophthalmic OCT imaging, corneal OCT imaging, retinal OCT imaging, and the like.

### REFERENCE TO CROSS RELATED APPLICATIONS

The instant application is a continuation-in-part application and claims priority to pending and now allowed U.S. application Ser. No. 12/941,991 filed on Nov. 8, 2010 and U.S. application Ser. No. 13/723,006 filed on 20 Dec. 2012. The disclosure is hereby incorporated by this reference in its entirety for all of its teachings.

### FIELD OF THE INVENTION

The present invention relates to the field of optical measurement devices. More particularly, the present invention relates to the field of optical test and measurement, interferometry, optical ranging and imaging, of a specimen using optical coherence tomography.

### BACKGROUND OF THE INVENTION

Optical coherence tomography (“OCT”) is a technology that allows for noninvasive, cross-sectional optical imaging in biological as well as non-biological media with high spatial resolution and high sensitivity. OCT is an extension of low coherence or white-light interferometry, in which a low temporal coherence light source is utilized to obtain precise localization of reflections internal to a probed structure along an optic axis (i.e., as a function of depth into the sample). An optical beam is directed at the tissue, and a small portion of this light that reflects from sub-surface features is collected. In the OCT instrument, an optical interferometer is used in such a manner as to detect only coherent light. In the process the depth and the intensity of the light reflected from a sub-surface feature is obtained. A three-dimensional image can be built by scanning, as in a sonar or radar system. The most commonly used interferometers in these devices are Michelson interferometer and Mach-Zehnder interferometer (MZI), which are well-known.

References [1, 2] report an interferometric system, which comprises a Michelson Interferometer for imaging using OCT. The signal is detected by a grating based spectrometer equipped with a linear detector array (or a line-scan camera). Further, OCT interferometric system known in the art are complex in arranging optical devices, expensive and are not portable.

### SUMMARY

In view of the foregoing disadvantages inherent in the prior art, the general purpose of the present invention is to provide a novel compact, affordable optical test, measurement or imaging device that is configured to include all advantages of the prior art, and to overcome the drawbacks inherent therein.

In one embodiment, a novel compact, affordable optical test, measurement or imaging device used for detection, imaging of ocular structures and pathology in diagnostic, diagnosis and pathogenesis is disclosed.

In another embodiment, a spectral-domain interferometric system that comprises a Mach-Zehnder interferometer, and an optical system laterally scanning the specimen is disclosed. Here and in the rest of the specifications, laterally scanning means scanning the beam in a direction perpendicular to the beam. Such a direction can be called x or y or any direction in x-y plane. Such lateral scanning provides multi-dimensional imaging as well as multi-dimensional metrology and multi-dimensional measurements. Lateral scanning can provide 2-dimensional or 3-dimensional images; 2-dimensional or 3-dimensional measurements; 2-dimensional or 3-dimensional metrology. Such lateral scanning also permits optical coherence tomography (OCT) imaging.

In another embodiment, an interferometric system that comprises a Mach-Zehnder interferometer, a frequency (i.e., wavelength)-tunable detector and optionally a lateral scanning (of the specimen) mechanism. A tunable detector as defined in this invention comprises of a tunable filter (preceding the detector), which separates the input broad-band light into light with narrow-band-wavelengths and outputs them sequentially at different time intervals in a single output fiber.

In an aspect of the present invention, an interferometric system for imaging a biological sample is provided. The interferometric system comprises a broadband light source, a plurality of beam splitters, a plurality of mirrors, a sample, a lateral scanning optical system, a tunable filter, a detector and a data processing system.

In another aspect of the present invention, a method for generating a tomographic image of a sample is provided. The method includes light from the broadband light source which is operating at a suitable center wavelength enters into a Mach-Zehnder interferometer where it gets separated into a sample arm and a reference arm using a first optic beam splitter. A light from the reference arm gets reflected by mirror and reaches a second beam splitter. A light from the sample arm enters into the sample through a third beam splitter by means of a lateral scanning optical system, and the back scattered light from the sample gets reflected at the third beam splitter (typically, but not limited to, 50% reflectance, 50% transmittance) through the lateral scanning optical system, and enters into a second beam splitter (typically, but not limited to, 99% transmittance, 1% reflectance). The light from the sample and reference arms, interfere with each other at the second beam splitter before entering a tunable filter which wavelength-division-multiplexes the interfered light, and then finally enters into a detector for analysis. Wavelength-division-multiplexing as defined in this invention is a process of separating the input broad-band light into light with narrow-bands-with various center-wavelengths and outputting them sequentially at different time intervals in a single output fiber.

These together with the other aspects of the present invention, along with the various features of novelty that characterized the present invention, are pointed out with particularity in the claims annexed hereto and form a part of the present invention. For a better understanding of the present invention, its operating advantages, and the specified object attained by its uses, reference should be made to the accompanying drawings and descriptive matter in which there are illustrated exemplary embodiments of the present invention.

### BRIEF DESCRIPTION OF THE DRAWINGS

Understanding of the present invention will be facilitated by consideration of the following detailed description of the preferred embodiments of the present invention taken in conjunction with the accompanying drawings, in which like numerals refer to like parts and in which:

FIG. 1 illustrates an optical diagram of a Michelson Interferometric optical coherence tomography apparatus and system as known in the art.

FIG. 2 is a flow chart illustrating a Michelson Interferometric optical coherence tomography system as known in the art.

FIG. 3 illustrates an optical diagram of a Michelson Interferometer apparatus and system configured with a tunable filter in accordance with an embodiment as disclosed.

FIG. 4 illustrates an optical diagram of a Michelson Interferometer apparatus and system configured with a tunable filter, a waveplate and a Faraday rotator mirror in accordance with an embodiment as disclosed.

FIG. 5 is a flow chart illustrating a Michelson interferometric system configured with a wavelength-tunable filter to analyze the sample in accordance with an embodiment as disclosed.

FIG. 6 is a flow chart illustrating a Michelson interferometric system configured with a wavelength-tunable filter, a waveplate and a Faraday rotator mirror in accordance with an embodiment as disclosed.

FIG. 7 illustrates an optical diagram of the Mach-Zehnder Interferometric apparatus and system as known in the art.

FIG. 8 is a flow chart illustrating a Mach-Zehnder interferometric system as known in the art.

FIG. 9 illustrates an optical diagram of the Mach-Zehnder Interferometric apparatus and system configured with a grating and a detector array in accordance with an embodiment as disclosed.

FIG. 10 is a flow chart illustrating a Mach-Zehnder interferometric system configured with a grating and a detector array to analyze the sample in accordance with an embodiment as disclosed.

FIG. 11 illustrates an optical diagram of the Mach-Zehnder Interferometric apparatus and system configured with a tunable filter in accordance with an embodiment as disclosed.

FIG. 12 is a flow chart illustrating a Mach-Zehnder interferometric system configured with a tunable filter to analyze the sample in accordance with an embodiment as disclosed.

FIG. 13 illustrates an optical diagram of the Mach-Zehnder Interferometric apparatus and system configured with an optical circulator to analyze the sample in accordance with an embodiment as disclosed.

Other features of the present embodiments will be apparent from the accompanying figures and from the detailed description that follows.

### DETAILED DESCRIPTION OF THE INVENTION

The present invention proposes an interferometric system for optical imaging, which is one of the major needs for refractive surgery, ophthalmic applications, corneal imaging, retinal imaging, endoscopic/catheter imaging, dental imaging etc. In particular, the invention is an integrated system for detection, ranging, metrology and multi-dimensional imaging.

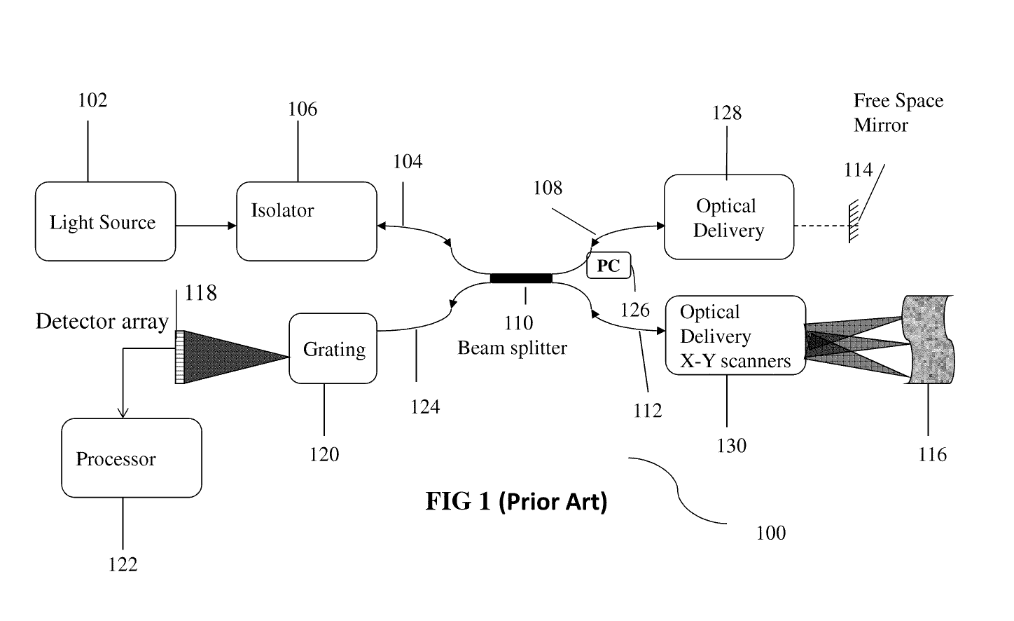

FIG. 1 illustrates a schematic figure of a Michelson Interferometric optical coherence tomography system (100) as known in the art. The interferometer (100) has a light source (102) operating at a suitable center wavelength and a suitable bandwidth. Some light sources may be sensitive to light reflected back from the interferometer. In order to protect such light sources, an optional isolator (106) may be used. The isolator absorbs the light received from the fiber optic beam splitter (110), and it stops the light from entering the source 102. In the interferometer, the source light is separated into the sample and reference arms using a fiber optic beam splitter (110). The beam-splitter 110 could also be a free-space beam-splitter for a free-space interferometer. The beam splitter is typically 50/50. The beam-splitter comprises of 4 arms. The source arm 104, which receives the light from the source and directs it to the beam-splitter to split the light into the reference arm 108 and the sample arm 112. The light returning from the reference and sample arms combines in the beam splitter and the light gets separated into the source arm (104) and the reflected sample arm or detector arm (124). The isolator absorbs the light received from the fiber optic beam splitter (110), and it stops the light from entering the source 102. The sample arm (108) comprises of a probe, which focuses light into the sample (116) using lateral Scanning Optical System unit (130) with x-y scanner and collects the backscattered light. The light in the detector arm is detected by a grating (120) based spectrometer equipped with a linear detector array (or a line-scan camera 118). The data from the camera or array is transferred to a processor 122, which is typically a desk-top computer.

In some existing system, if the beam-splitter 110 is fiber-optic, the means to adjust polarization are used in the form of a fiber optic polarization compensator (PC) (126), which is made up of fiber optic loops, in the reference arm 108 to match the polarization in both the sample and reference arms. Such matching provides optimal interference signal strength. The PC 126 could be placed either in the sample arm or the sample arm.

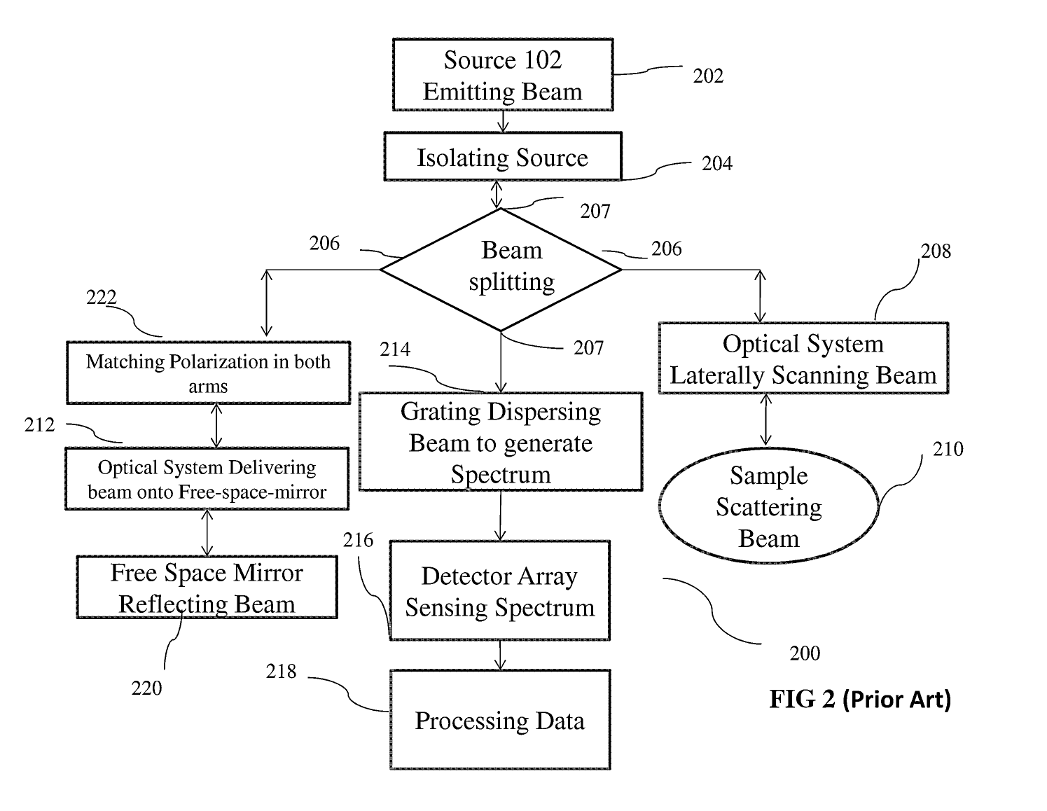

FIG. 2 is a flow chart (200) illustrating an Optical Coherence Tomography (OCT) measurement system based on a Michelson interferometer as known in the art. As illustrated, methodology starts at step (202), wherein the source 102 emits a beam of light which optionally passes through an isolator at step 204. While the apparatus, system and method would work for both broad-band and narrow-band light, a broad-band light is preferred for OCT. The beam passes a first beam splitter (110) (typically 50/50) at step (206) getting divided into two separate light beams known as reference arm (108) and sample arm (116). The light returning from the sample and reference arms is also received at step 206 and separates into the source arm (104) and detector arm (124). In the reference arm 108, at step 222, the polarization is optionally matched using a polarization compensator PC (126) in the reference arm in order to provide optimal interference signal strength. The fiber optic polarization compensator (PC) (126) is made up of fiber optic loops. The PC 126 could be placed either in the sample arm or the reference arm.

At step 212, an optical delivery system (128) delivers the light beam onto a free-space-mirror (114) in the reference arm. The free-space-mirror reflects back the light beam to the optical delivery system at step 220. The light from the reference arm returns to the beam splitter 110 at step 206 and splits into source arm and detector arm at step 207. In the sample arm 112, at step (208), the beam passes through lateral scanning optical delivery system (130), it comprises of x-y scanner) and falls upon the sample at step (210). The sample arm beam is reflected and/or scattered back after it strikes the sample and returns to the beam splitter 110 and splits into source arm and detector arm at step 207. The light returning from the reference arm (108) and sample arms (112) interferes at step (207); known as the interference light beam entering the detector arm 124. The light beam is dispersed by a grating (120) at step 214. The dispersed light, also called a spectrum is sensed by an array of detectors (118), at step 216. The components 118 and 120 form a spectrometer sub-system, and optionally may comprise of lenses, mirrors and/or other optical components to facilitate optical beam propagation and maximize optical signal. The spectral data measured by the detector array are transferred to a processor (122), typically a computer, for further processing at step 218. The data may be transferred by a USB cable, or a camera-link cable or an Ethernet cable.

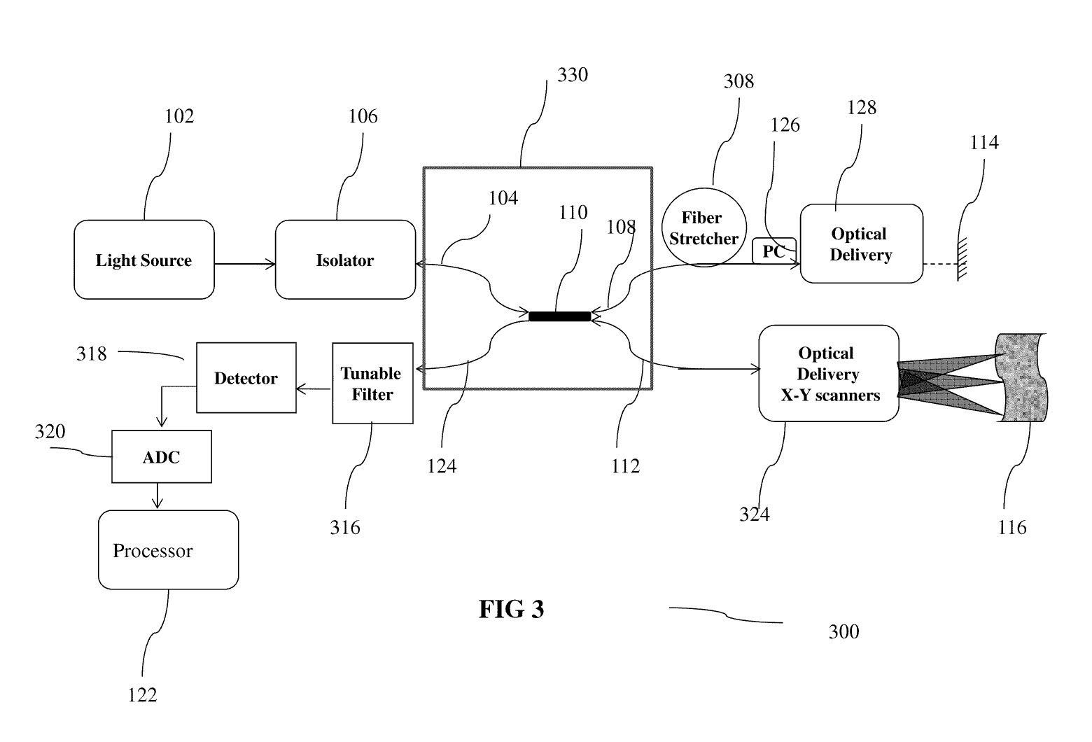

FIG. 3 illustrates an optical diagram of a Michelson Interferometric optical coherence tomography system (300), in accordance with an embodiment of the present invention. Most components are similar to the system described in FIG. 1. Fiber stretcher 308 comprises of a fiber looped around a piezoelectric device (which is a solid block that can be expanded or contracted by electric voltage). The purpose of a fiber stretcher is to increase or decrease the path-length in the interferometer that is on the reference arm by increasing or decreasing the fiber-length. Although the fiber stretcher 308 is shown in the reference arm, it can be placed either in the reference arm or sample arm. If the fiber stretcher 308 is kept in the reference arm, since the fiber is looped around the piezoelectric device, care must be taken to provide extra fiber in the sample arm so that the sample arm and reference arm path lengths are matched. According to one more embodiment, the Michelson interferometric system comprises of the means to adjust polarization in the sample arm (112) to match the polarization in the reference arm (108) to achieve optimal signal strength.

According to an embodiment of the instant invention, the light in the detector arm 124 enters a tunable filter (316) for wavelength-division-multiplexing. Wavelength-division-multiplexing as defined in this invention is a process of separating the input broad-band light into light with narrow-bands with various center-wavelengths and outputting them sequentially at different time intervals in a single output fiber.

This tunable filter (316) can be e.g., (by example, but not limited to) a Fabry Perot interferometer tunable filter or a tunable filter based on a grating light valve (GLV) or an acousto-optic tunable filter or a grating based tunable filter or any other interference filter. The multiplexed data are detected by a detector (318), are digitized by an analog to digital converter (ADC) 320, and are forwarded to a data processing unit or a processor (320) for analyzing the data. A tunable filter as defined in this invention separates the input broad-band light into light with narrow-band-(“tuned”) wavelengths and outputs them sequentially at different time intervals in a single output fiber.

According to one more embodiment, the Michelson interferometric system may be used as a multi-dimensional metrology system by laterally scanning the beam incident on at least one sample (116) by means of an optical system 324. Per one more embodiment, the lateral scanning in the optical system 324 is achieved by using a micro electro mechanical system (MEMS) or micro-opto-mechanical system (MOMS) mirrors and lenses in the Michelson interferometric system. The lateral scanning in the optical system 324 could also be achieved by traditional galvanometric mirrors. All the major components of the Michelson interferometer including 110, 104, 108,124, 112, form an interferometer sub-assembly 330. A Michelson interferometer can be built using a photonic integrated circuit using waveguides as described in F. Morichetti, et. al. (2007), and Duc Nguyn et al (2013). The technology is based on Si₃N₄ and SiO₂ waveguide technology called TriPleX®, which has been developed by LioniX BV (Enschede, The Nederlands) as described in the article above by Morichetti et al. In an embodiment the interferometer sub-assembly 330 can be a photonic integrated assembly. The fiber components 108, 104, 124 and 112 would turn into waveguides in such an integrated assembly. The lengths of waveguides 108 and 112 can be adjusted to match the path-lengths in reference and sample arms. Fiber stretcher 308 can optionally be used. The polarization compensator PC 126 need not be part of this integrated circuit. PC is needed primarily for fiber-optic interferometer, and can be used if there is an optical-fiber in the system even after using the integrated circuit. The Photonic integrated circuits can be built using many types of material system by way example, but not by limitation; silica on silicon, lithium niobate electro-optic crystals, Silicon on insulator, many polymers, semiconductor material such as GaAs & InP.

In an embodiment, the Michelson interferometric system design results in reducing the size of the system to form a compact or portable system or an embedded single integrated circuit (i.e., a system on chip (SOC)). Thus the interferometric system can be made a compact, portable system using an embedded single integrated circuit. The photonic integrated circuit described above can comprise of the Michelson interferometer 330, and tunable filter 316. The light source 102, the detector 318, could also be optionally included on the same photonic circuit. The isolator 106, the ADC 320 and the processor 122 could also be included in the same integrated circuit or the same chip. The isolator 106, the ADC 320 and the processor 122 and the interferometer could also be built using separate chips, which communicate with each other.

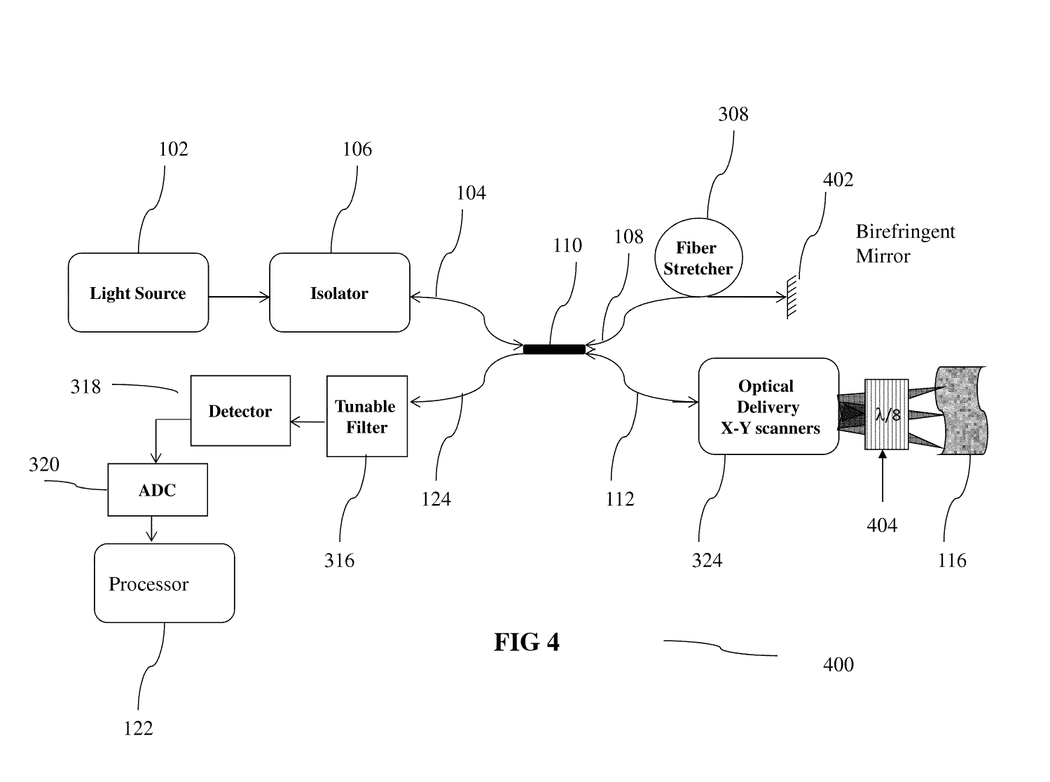

FIG. 4 illustrates an optical diagram of a Michelson Interferometric optical coherence tomography system (400), in accordance with an embodiment of the present invention. Most components are similar to those in the system described in FIG. 3. Birefringent mirror is used in the reference arm, and hence the polarization compensator is not needed. This birefringent mirror 402 can be a Faraday rotator mirror 402, which is an off-the-shelf part. U.S. patent application Ser. No. 13/723,006 describes this component in detail and we herewith incorporate it as a reference. Faraday rotator mirror comprises of a fiber-optic mirror preceded by a 45 degrees (λ/8) Faraday rotator. The polarization of the light incident on the Faraday rotator is rotated by 45 degrees, and is directed to the mirror. The reflected light is further rotated by 45 degrees by the Faraday rotator and hence the resulting polarization is orthogonal to incident polarization. Such an arrangement cancels fiber-birefringence effects. We could also use a fractional wave mirror as described in U.S. patent application Ser. No. 13/723,006 as a fiber optically integrated birefringent reference mirror 402. As described in U.S. patent application Ser. No. 13/723,006, the fractional wave mirror comprises of a fiber-optic mirror preceded by a fractional [45 degrees (λ/8)] waveplate. The polarization of light incident on the wave plate is rotated by 45 degrees, and is directed to the mirror. The reflected light is further rotated by 45 degrees by the fractional [45 degrees (λ/8)] waveplate and hence the resulting polarization is orthogonal to the incident polarization.

In some embodiments, the reference arm path is an optical fiber terminated by a fiber integrated mirror instead of a birefringent mirror (402).

In some embodiments, one can include by way of example but not by limitation a 45 degrees λ/8 wave plate 404 in the sample arm before the light is incident on the sample 116. The λ/8 wave plate may be placed in the sample arm just before the light is incident the light is incident on the optical delivery unit 324. Since the polarization of the retro reflected light will be almost orthogonal to the incident light (considering the fact that the birefringence in the specimen 116 will modify the polarization state), the birefringence effects in the sample arm fiber 112 of the interferometer 400 will get cancelled. In a preferred embodiment, the λ/8 waveplate 404 is constructed using fiber optic components.

The effect of fiber-birefringence phenomenon (affecting the polarization of the light in the sample and reference arms) gets minimized due to arrangement of the birefringent mirror in the reference arm and λ/8 wave plate in the sample arm. Therefore, polarization in the sample and reference arms is closely matched, and a separate polarization compensator is not needed. According to one embodiment, the Michelson interferometric system 300 comprises of a beam-splitter (110) which can be a fiber-optic coupler. According to another embodiment, the Michelson interferometric system 300 comprises of, the reference arm path, which is an optical fiber terminated by a fiber integrated mirror instead of free-space-mirror.

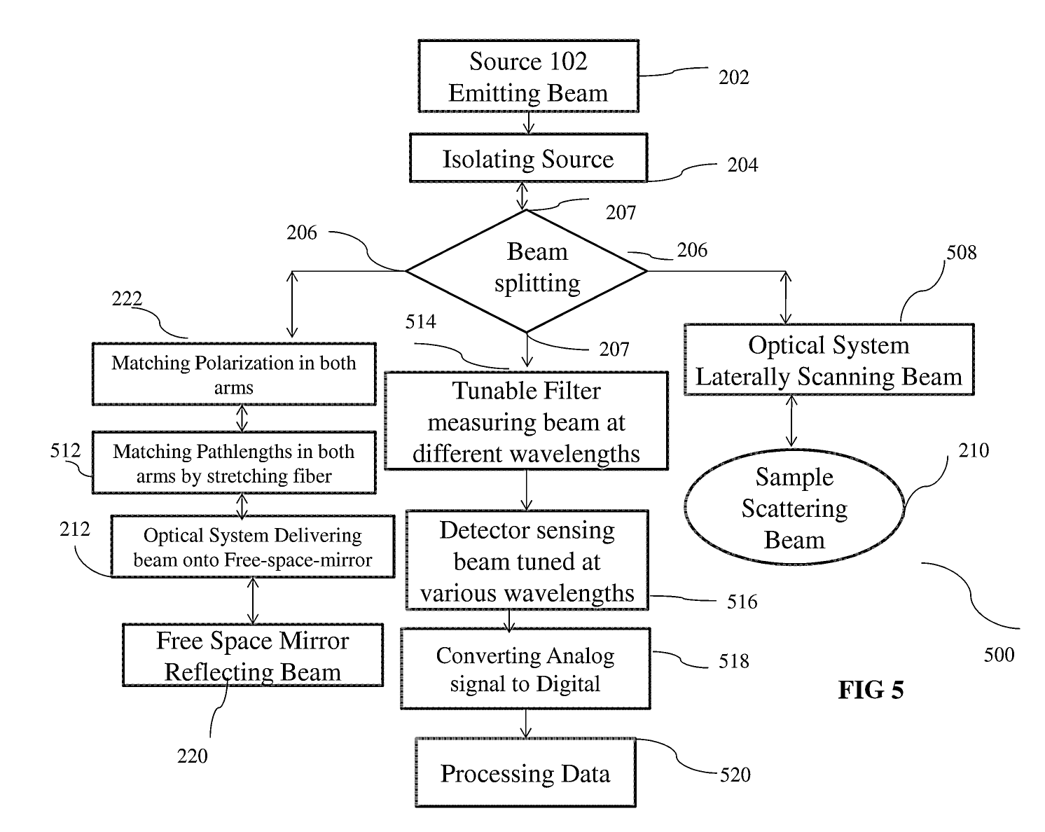

FIG. 5 is a flow chart 500 of method of using the Michelson Interferometer apparatus in FIG. 3. Most steps are similar to the flow-chart in FIG. 2. However, we highlight the novel steps. The beam returning from the reference arm (108) and sample arm (112) interferes at step (207); known as interfered light beam or the interference light beam entering the detector arm 124. At step (508), the beam passes through lateral scanning optical delivery system (324, it comprises of x-y scanner) and falls upon the sample at step (210). Per one more embodiment, the lateral scanning in the optical system 324 is achieved by using a micro electro mechanical system (MEMS) or micro-opto-mechanical system (MOMS) mirrors and lenses in the Michelson interferometric system. The interfered light or The interference light beam in the detector arm enters a tunable filter (316) at step (514) where wavelength division multiplexing of interfered light beam (124) takes place. The multiplexed data are sensed by a detector 318 at step (516) and are digitized by an analog to digital converter (ADC) 320 at step 518, and are forwarded to a data processing unit or a processor (320) for analyzing the data at step 520.

This tunable filter can be e.g., (by example, not by limitation) a Fabry Perot interferometer tunable filter or a tunable filter based on a grating light valve (GLV) or an acousto-optic tunable filter or a grating based tunable filter or any other interference filter. A tunable filter as defined in this invention separates the input broad-band light into light with narrow-band-(“tuned”) wavelengths and outputs them sequentially at different time intervals in a single output fiber.

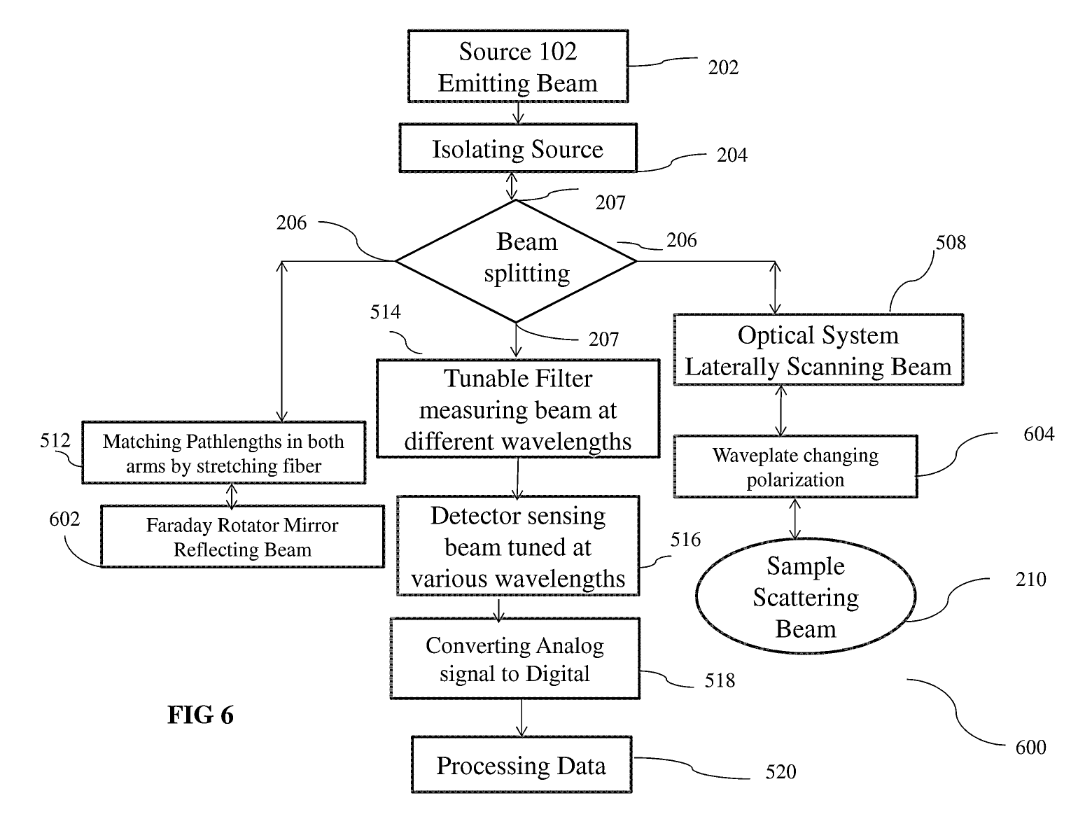

FIG. 6 is a flow chart 600 of method of using the Michelson Interferometer as an apparatus in FIG. 4. Most steps are similar to the flow-chart in FIG. 5. Here we highlight the unique steps and differences. In the reference arm, step 212 of polarization compensation is not needed due to step 602 of the fiber optically integrated birefringent reference mirror (402) or the Faraday Rotator Mirror (402) reflecting the beam. Since the mirror 402 is fiber-optically integrated, the step 212 of delivering the beam onto a free-space mirror is not needed.

In the sample arm, an additional step 604 of the λ/8 wave plate 404 changing the polarization is introduced. While the step 604 is shown after the step 208, it can be performed before or after the step 208. The beam exiting the waveplate is incident on the sample in step 210. In another embodiment (not shown), the beam exiting sample arm fiber 112 enters the waveplate 404 in step 604. The beam exiting the waveplate 404 is incident on the optical delivery system 324 (laterally scanning the beam) in step 508. The beam exiting the optical delivery system 324 is incident on the sample in step 210.

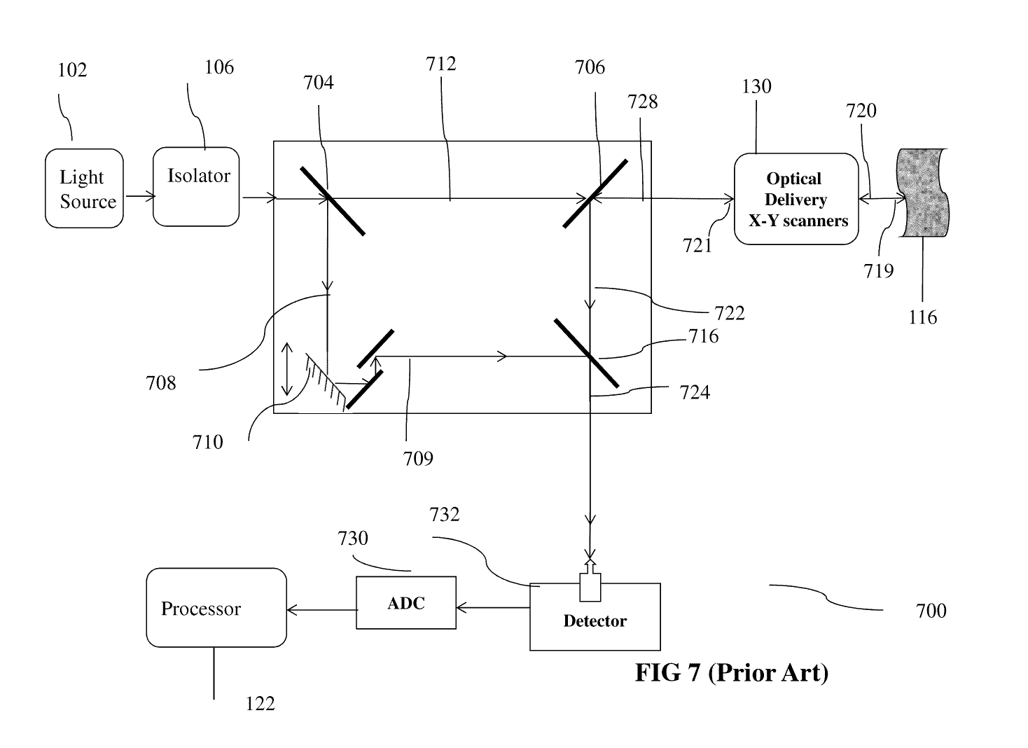

In U.S. Pat. No. 7,079,256 B2, the Mach-Zehnder interferometer (MZI) is built using bulk optical elements and uses time-domain form of optical coherence-tomography. FIG. 7 illustrates an optical diagram of a Mach-Zehnder Interferometric optical coherence tomography system (700) configured with a detector as known in the art. In the system source 102 emits a beam of light which passes through an isolator (106). The light can optionally be broadband light. The beam splits at the first beam splitter (704) (typically, but not limited to, 99% Transmittance and 1% Reflectance) getting divided into two separate light beams known as reference arm or reference path (708) and sample arm or sample path (712). The reference arm beam (708) is reflected by a scanning mirror 710 towards a second beam splitter (716) (typically, but not limited to, 99% Transmittance and 1% Reflectance). The beam reflected from the mirror 710 is labeled (709). The retroreflector (710) moves back and forth to change the optical path-length. The scanning mechanism (710) is shown for an illustration purpose only, and many other mechanisms are possible to change the path-length in the reference arm. The sample arm beam (712) is passed through a third beam splitter (706) (typically 50% Reflectance and 50% Transmittance) to provide beam 721 which reflects the light to an optical delivery X-Y scanner system (130). In an embodiment, the optical delivery X-Y scanner system (130) may be a lateral scanning optical system. The beam (719) in the sample arm passes through lateral scanning optical system and falls upon the sample (116). According to one embodiment, the sample (116) can be a scattering medium or a biological specimen. The sample beam is scattered and/or reflected back after it strikes the sample and is known as the backscattered sample beam (720). The backscattered sample beam (720) passes the lateral scanning optical system (324) and is labeled (728) and strikes the second beam splitter (706) (typically 50% Reflectance and 50% Transmittance). The third beam splitter (706) reflects the backscattered sample beam (728) to the second beam splitter (716) (typically, but not limited to, 1% Reflectance and 99% Transmittance) and is labeled (722).

The reference arm beam (709) reflected from mirror 710 gets reflected at the beam-splitter 716 towards the detection optics and electronics. The backscattered sample arm beam (722) reflected from third beam splitter (706) gets transmitted through the beam-splitter 716. Both the beams 709 and 722 interfere with each other at the beam-splitter 716. The interference light beam (724) enters a detector 732 (typically slower than the detector 318 used in our embodiment), which converts light to an electric signal. The electric signal is sent to analog to digital converter (ADC) (730, typically slower than the ADC 320 used in our embodiment) for digitization. The data from the ADC is transferred to a processor 122, which is typically a desk-top computer. The data may be transferred to the processor by a USB cable or any other form of computer communication.

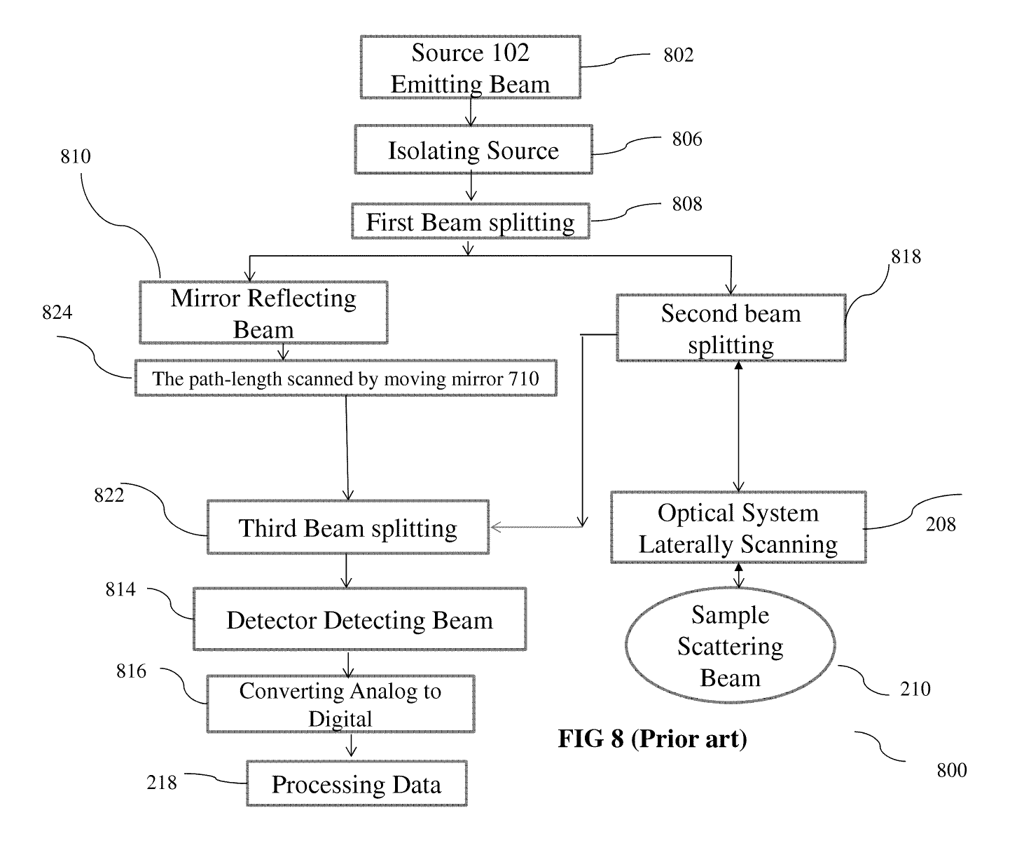

FIG. 8 illustrates a flow-chart (800) of a method to use Mach-Zehnder Interferometric optical coherence tomography system (700) configured with a detector as known in the art. In the step 802, system source 102 emits a beam of broadband light which passes through an isolator (106) in step 806. The beam splits at the first beam splitter (704) (typically, but not limited to, 99% Transmittance and 1% Reflectance) getting divided into two separate light beams known as reference arm (708) and sample arm (712) in step 808. The reference arm beam (708) is reflected by a scanning mirror 710 towards the second beam splitter (716) (typically, but not limited to, 99% Transmittance and 1% Reflectance) in step 810. The path-length is scanned by a scanning mirror 710 at step 824. The scanning mechanism (710) is shown for an illustration purpose only, and many other mechanisms are possible. At step 818, the sample arm beam (712) is passed through a third beam splitter (706) (typically, but not limited to, 50% Reflectance and 50% Transmittance) to provide beam 721. At step 208, the beam (721) is reflected to an optical delivery X-Y scanner system (324). In an embodiment, the optical delivery X-Y scanner system (324) may be a lateral scanning optical system. Per one more embodiment, the lateral scanning in the optical system 324 is achieved by using a micro electro mechanical system (MEMS) or micro-opto-mechanical system (MOMS) mirrors and lenses in the Mach-Zehnder interferometric system.

At step 210, the beam (721) in the sample arm passes through lateral scanning optical system and falls upon the sample (116). The incident beam is labeled as (719). At step 210, the sample beam is scattered and/or reflected back after it strikes the sample and is known as the backscattered sample beam (720). At step 208, the backscattered sample beam (720) passes the lateral scanning optical system (324) and strikes the third beam splitter (706) (typically 50% Reflectance and 50% Transmittance). At step 818, the third beam splitter (706) reflects the backscattered sample beam (728) to the second beam splitter (716) (typically, but not limited to, 1% Reflectance and 99% Transmittance) and the beam is labeled (722).

At step 822, the reference arm beam (709) reflected from mirror 710 gets reflected at the beam-splitter 716 towards the detection optics and electronics. The backscattered sample arm beam (722) reflected from third beam splitter (706) gets transmitted through the beam-splitter 716. At “Detector detecting beam” of step 814, both the beams 709 and 722 interfere with each other at the beam-splitter 716. At step 814, the interference light beam (724), enters a detector 732 (typically slower than the detector 318 used in our embodiment), which converts light to an electric signal. At step 816, the electric signal is sent to analog to digital converter (ADC) (730, typically slower than the ADC 320 used in our embodiment) for digitization. At step 218, the data from the ADC is transferred to a processor 122, which is typically a desk-top computer. At step 218, the data may be transferred to the processor by a USB cable or any other form of computer communication.

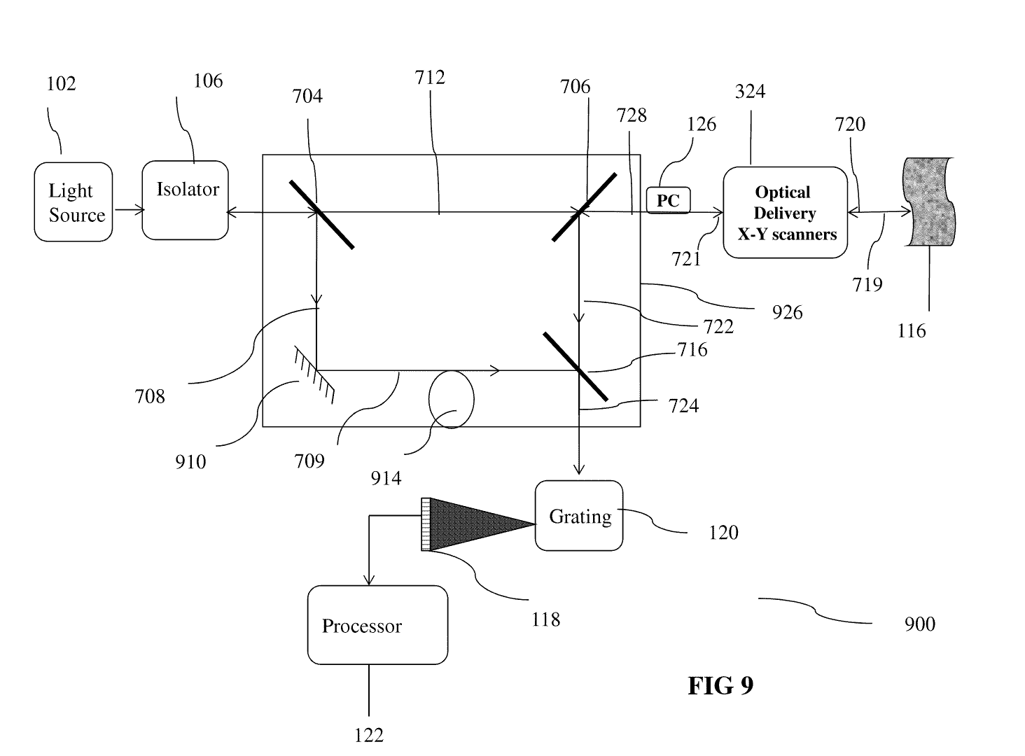

FIG. 9 illustrates an optical diagram of a Mach-Zehnder Interferometric optical coherence tomography system (900) configured with a spectroscopic detection system per an embodiment of the instant invention. Most of the apparatus is similar to that in FIG. 7. Here we highlight the differences. The reference arm beam (708) is reflected by a mirror 910 towards the second beam splitter (716) (typically, but not limited to, 99% Transmittance and 1% Reflectance). The beam reflected from the mirror 910 is labeled (709). In an embodiment, the optical delivery X-Y scanner system (324) may be a lateral scanning optical system. The backscattered sample beam (720) passes the lateral scanning optical system (324) and is labeled (728) and strikes the third beam splitter (706) (typically, but not limited to, 50% Reflectance and 50% Transmittance). The third beam splitter (706) reflects the backscattered sample beam (728) to the second beam splitter (716) (typically, but not limited to, 1% Reflectance and 99% Transmittance) and is labeled (722).

At step 508, the beam (721) is reflected to an optical delivery X-Y scanner system (324). In an embodiment, the optical delivery X-Y scanner system (324) may be a lateral scanning optical system. Per one more embodiment, the lateral scanning in the optical system 324 is achieved by using a micro electro mechanical system (MEMS) or micro-opto-mechanical system (MOMS) mirrors and lenses in the Mach-Zehnder interferometric system. According to one embodiment, the sample (116) can be a scattering medium or a biological specimen.

The reference arm beam (709) reflected from mirror 910 gets reflected at the beam-splitter 716 towards the detection optics and electronics. The backscattered sample arm beam (722) reflected from third beam splitter (706) gets transmitted through the second beam-splitter 716. Both the beams 709 and 722 interfere with each other at the beam-splitter 716. The interference light beam (724), enters a grating (120) based spectrometer equipped with a linear detector array (or a line-scan camera 118). The components 118 and 120 form a spectrometer sub-system, and optionally may comprise of lenses, mirrors and/or other optical components to facilitate optical beam propagation and maximize optical signal. The data from the camera or array is transferred to a processor 122, which is typically a desk-top computer. The processor could also be a tablet computer or a lap-top computer or a desktop computer or a smart phone or an embedded system per an embodiment of the invention. The data may be transferred to the processor by a USB cable, or a camera-link cable or an Ethernet cable or a wireless connection such as a blue-tooth connection.

The reference arm beam (709) reflected from mirror 710 gets transmitted through a fiber stretcher 914, which comprises of a fiber looped around a piezoelectric device. The purpose of a fiber stretcher is to increase or decrease the path-length in the interferometer on the reference arm by increasing or decreasing the fiber-length. Although the fiber stretcher 914 is shown in the reference arm, it can be placed either in the reference arm or sample arm. If the fiber stretcher 914 is kept in the reference arm, since the fiber is looped around the piezoelectric device, care must be taken to provide extra fiber in the sample arm so that the sample arm and reference arm path lengths are matched. In an embodiment, if there is a fiber optic component in the sample path, a polarization compensator (PC) 126 is placed in the sample arm to match the polarization in the reference and sample arms.

All the major components of the Mach-Zehnder interferometer including 704, 708, 910, 712, 706, 728, 721, 722, 716, 724, 914, 709 form an interferometer sub-assembly 926. A Mach-Zehnder interferometer can be built using a photonic integrated circuit using waveguides as described in F. Morichetti, et. al. (2007). The technology is based on Si₃N₄ and SiO₂ waveguide technology called TriPleX™, which has been developed by LioniX BV (Enschede, The Nederlands) as described in the article above by Morichetti et al. In an embodiment the interferometer sub-assembly 926 can be a photonic integrated circuit. The Photonic integrated circuits can be built using many types of material system by way example, but not by limitation; silica on silicon, lithium niobate electro-optic crystals, Silicon on insulator, many polymers, semiconductor material such as GaAs & InP.

In an embodiment, the Mach-Zehnder interferometric system design results in reducing the size of the system to form a compact or portable system or an embedded single integrated circuit (i.e., a system on chip (SOC)). Thus the intererometric system can be made a compact, portable system using an embedded single integrated wafer or chip or circuit. The photonic integrated circuit described in above can comprise of the Mach-Zehnder interferometer 926, and tunable filter 316. The light source 102, the detector 318, could also be optionally included on the same photonic circuit or the same chip. The isolator 106 the ADC 320 and the processor 122 could also be included in the same integrated circuit or the same chip. The isolator 106 the ADC 320 and the processor 122 and the interferometer could also be built using separate chips, which communicate with each other.

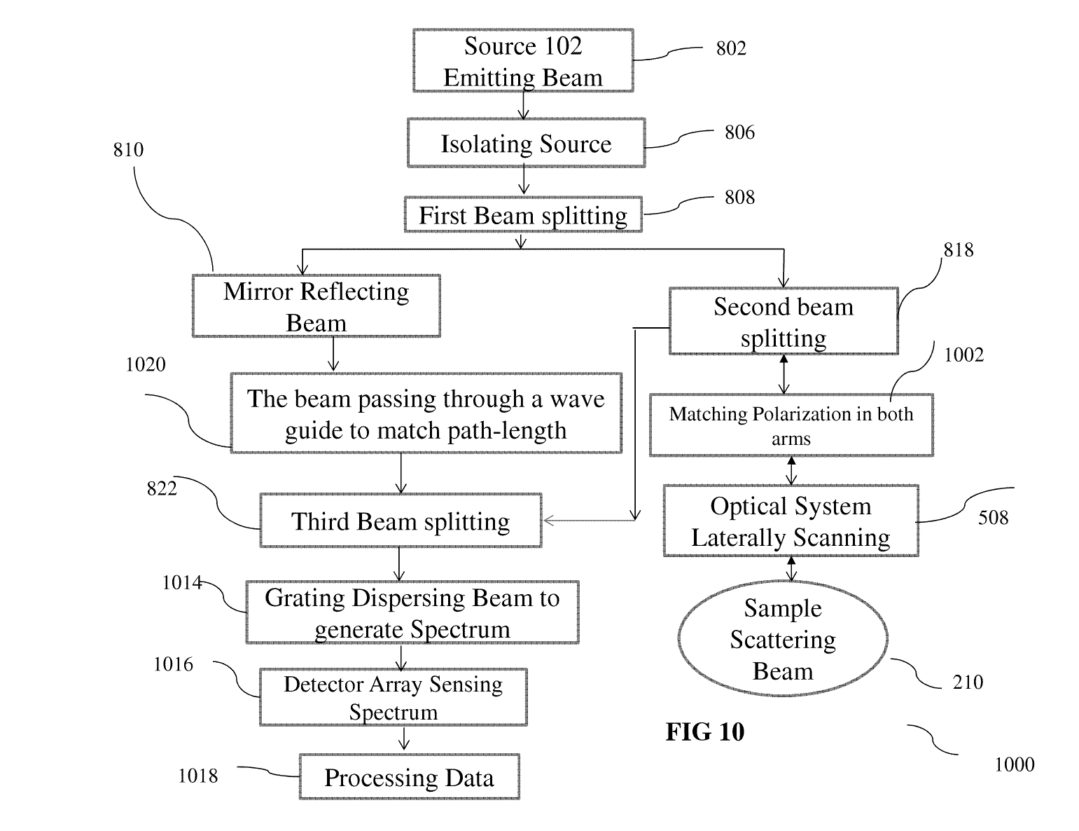

FIG. 10 illustrates a flow-chart (1000) of a method to use Mach-Zehnder Interferometric optical coherence tomography system (900) configured with a grating based spectrometer per an embodiment of the present invention. Most of the steps are similar to those in FIG. 8. In step 1020, the beam 709 is passed through a wave guide 914 to match the path-length. The wave guide could be an optical fiber or non-fiber waveguide. In step 1002, polarization is matched in the reference and sample arms using the PC 126. The detection is changed as shown in steps 1014, 1016, and 1018. In step 1014, the light 724 is dispersed by grating 120. In step 1016, the dispersed spectrum is measured by a detector array. In step 1018, the data are processed. The data from the camera or array is transferred to a processor 122, which is typically a desk-top computer. The processor could also be a tablet computer or a lap-top computer or a desktop computer or a smart phone or an embedded system per an embodiment of the present invention. The data may be transferred to the processor by a USB cable, or a camera-link cable or an Ethernet cable or a wireless connection such as a blue-tooth connection.

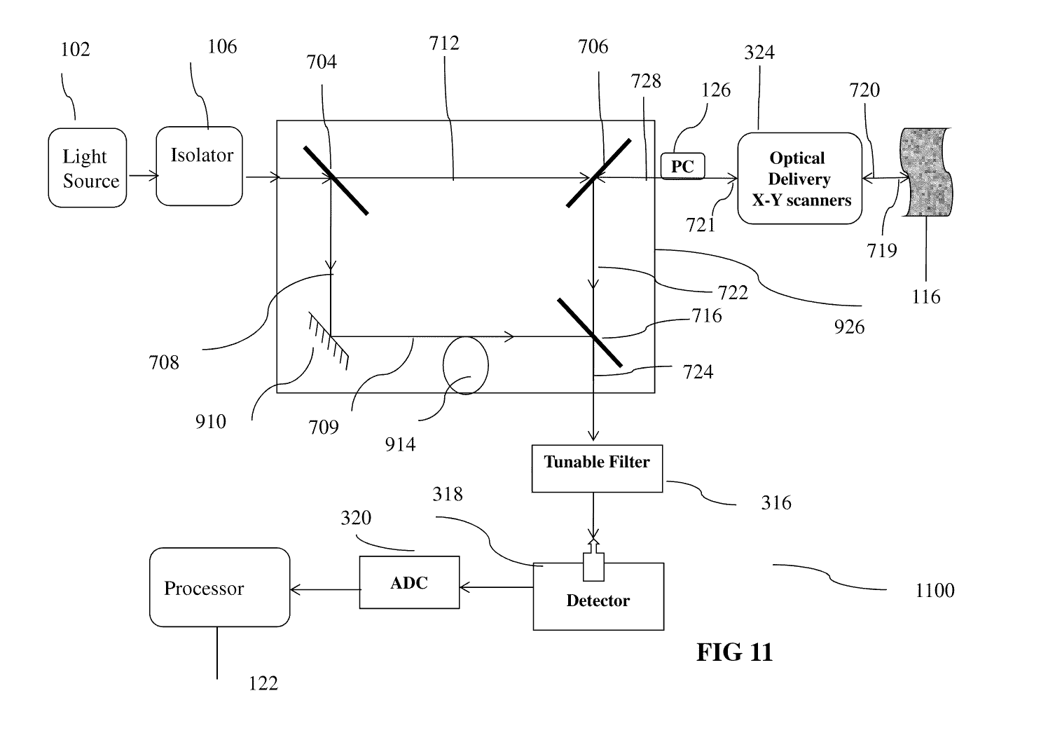

FIG. 11 illustrates an optical diagram of a Mach-Zehnder Interferometric optical coherence tomography system (1100) configured with a tunable filter, in accordance with an embodiment of the present invention. In an embodiment, the interference light beam (724) enters a tunable filter (316) such as a Fabry Perot tunable interference filter or a filter comprising of a grating light valve (GLV). In the tunable filter 316, wavelength division multiplexing of interfered light beam (124) takes place. The multiplexed data enters a high speed detector 318 which converts light into an electronic signal. The signal is digitized by a high-speed analog to digital converter (ADC) 320 for further processing using a Processor (122). Wavelength-division-multiplexing as defined in this invention is a process of separating the input broad-band light into light with narrow-band-wavelengths and outputting them sequentially at different time intervals in a single output fiber.

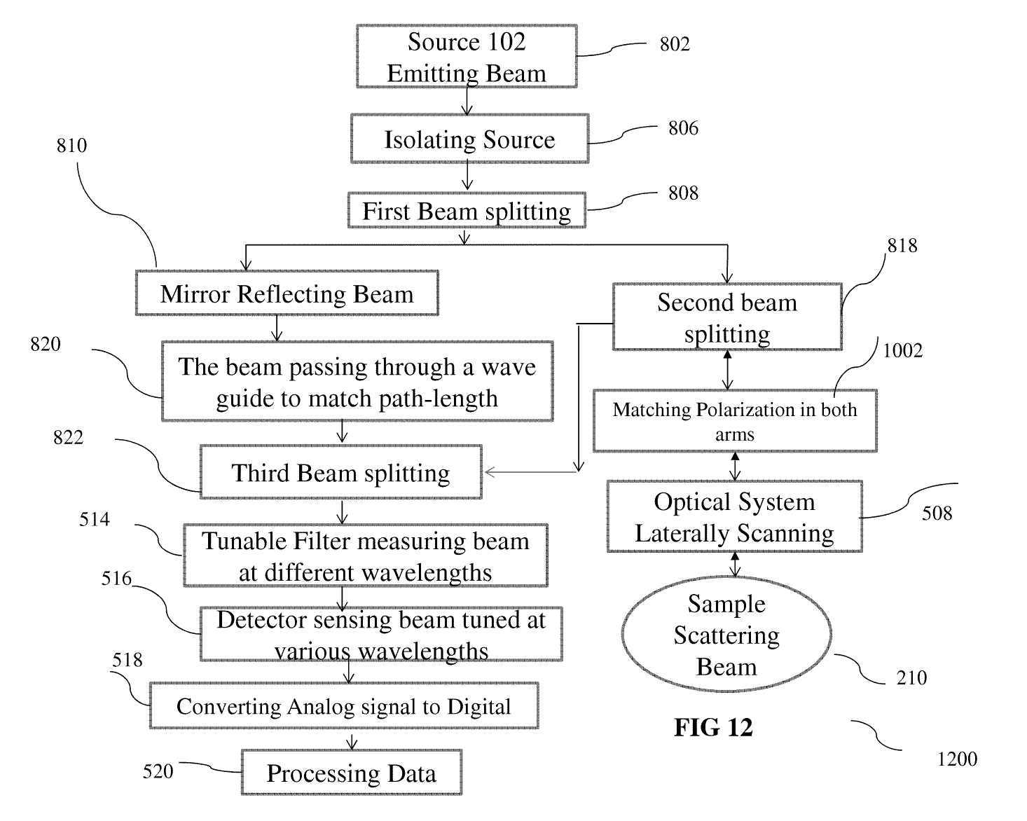

FIG. 12 illustrates a flow-chart (1200) of a method to use Mach-Zehnder Interferometric optical coherence tomography system (1100) configured with a tunable filter per an embodiment of the present invention. Most of the steps are similar to those in FIG. 10. Only steps 514, 516, 518, and 520 are different. The interfered light in the detector arm enters a tunable filter (316) at step (514) where wavelength division multiplexing of interfered light beam (124) takes place. The multiplexed data are sensed by a fast detector 318 at step (516) and are digitized by a fast analog to digital converter (ADC) 320 at step 518, and are forwarded to a data processing unit or a processor (320) for analyzing the data at step 520.

The processor could also be a tablet computer or a lap-top computer or a desktop computer or a smart phone or an embedded system. The processor could also use a FPGA or a graphics cord a GPU (graphical processing unit). The data may be transferred to the processor by a USB cable, or a camera-link cable or an Ethernet cable or a wireless connection such as a blue-tooth connection. According to an embodiment in the proposed Mach-Zehnder interferometric system, the lateral scanning (324) is achieved by a micro electro mechanical system (MEMS) or micro-opto-mechanical system (MOMS) mirrors and lenses. The Mach-Zehnder interferometric system may be multi-dimensional metrology system by laterally scanning the beam incident on the sample (116) by means of an optical system. The Mach-Zehnder interferometric system can comprise of at least one sample (116) which is a scattering medium or a biological specimen.

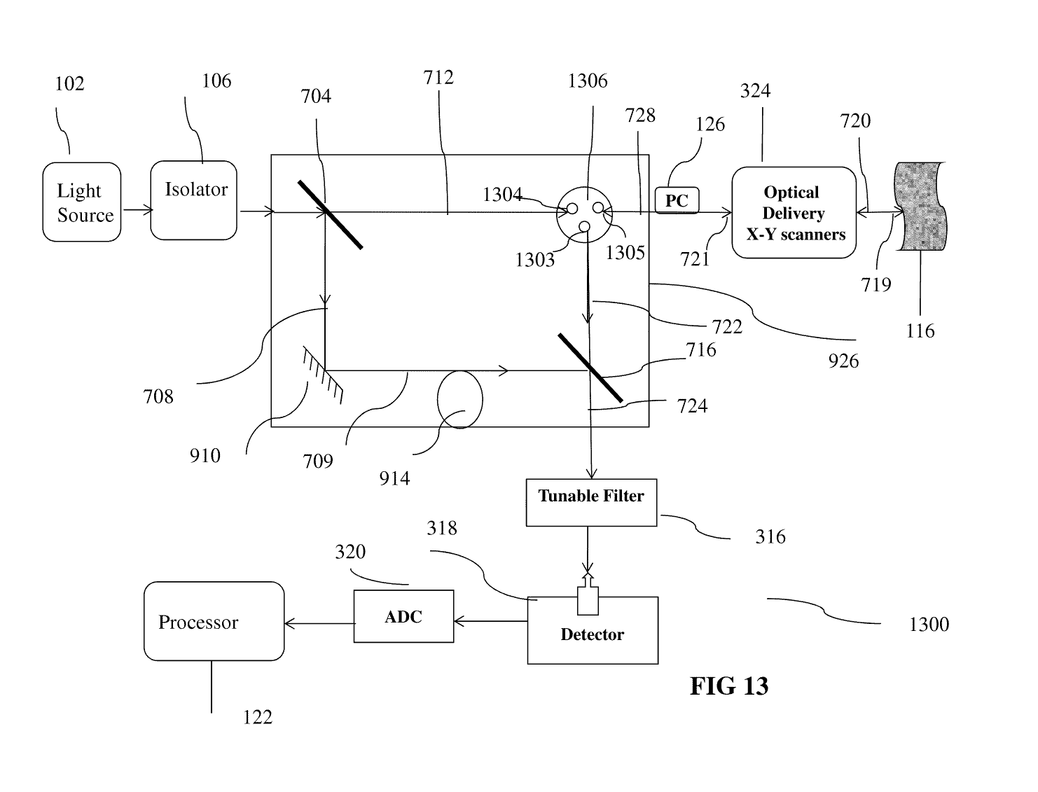

FIG. 13 illustrates an optical diagram of a Mach-Zehnder Interferometric optical coherence tomography system (1300) configured with a tunable filter and optical circulator 1306, in accordance with an embodiment of the present invention. Optical circulator 1306 replaces the beam splitter 706. In FIG. 13, the light from port 1304 goes to port 1305, and the light from port 1305 goes to port 1303. That way minimal loss of light occurs while delivering light to the specimen 116.

DIFFERENT TYPES OF TUNABLE FILTERS (316): Many candidates are available for the tunable filter (316). These include acousto-optic tunable filters, or a tunable interference filter or a grating-based filter or grating light valve (GLV) based filter or a tunable Fabry-Perot interference filter, etc. The traditional spectral domain OCT system use a broad-band source and a spectrometer as shown in FIG. 1. However, replacing the spectroscopic detection using the tunable filter and a single detector reduces the cost as we do not need to use a full line-scan camera. Since there is only 1 detector, our invention provides the following advantages: smaller form factor, lower cost, and higher efficiency. The spectroscopic detection system has a finite spectral resolution (typically 0.04-0.06 nm/pixel), causing the reduction in signal strength in deeper regions of the image. The tunable filter can provide a much smaller line-width on the order of 0.01 nm per each tuned wavelength. There are inherent losses in a grating based spectrometer (sometimes as high as 70-90%). Those losses are minimized in the proposed invention. Typical insertion loss in a Fabry-Perot based tunable filter is 2-3 dB.

The line-width (also known as bandwidth) of the tunable filter can be as small as (as an example, not a limitation) 0.005 nm. This bandwidth is typically specified as −3 dB bandwidth, which means the width of the filter where the gain of the filter is the half of that of the gain at the center wavelength.

The tuning range of the filter 316 can typically be 50-200 nm and the scan speed can typically range from 1 kHz till 200 kHz, although there is no minimum or maximum tuning range & speed range requirement per the proposed invention. For example, if the scan-speed is 100 kHz, that means each spectrum is measured at s=100 kHz speed. If the tuning range is R=50 nm, and the line-width (lw) is 0.02 nm, the detector 318 needs to measure 2500 points (p=R/lw) per spectrum. That means the detector 318 would need to detect f1=p*s=250 Mega-samples per second. In order to follow the Nyquist criteria, the detector needs to have a pass-band up to fpb=2*f1=0.5 GHz or more. The ADC 320, need to be able to convert 250 Mega-samples/second or more at typically 8-bits to 12 bits resolution. That would mean the ADC speed would need to be at least 3-Gigabits per second for a 12-bit conversion of 250 Mega-samples/second. The data are treated as spectra measured from a spectrometer. The data are processed in the same way the data are processed in spectral domain OCT system (FIG. 11-13 in U.S. application Ser. No. 13/723,006).

Fabry Perot Tunable Filter: The following is a commercially available tunable filter, which can be used as a tunable filter 316. It is based on Fabry-Perot interferometer. The interferometer cavity is resonating. The wavelength tunability performance is enhanced by very high quality reflector coatings. The device does not have any moving parts and it is shock-resistant. The line-width (also known as bandwidth) of the filter can be as small as (as an example, not a limitation) 0.01 nm. This bandwidth is typically specified as −3 dB bandwidth, which means the width of the filter where the gain of the filter is the half of that of the gain at the center wavelength. The tuning range can typically be 50-200 nm, although there is no minimum or maximum tuning range requirement per the proposed invention. The scan speed can typically range from 1 kHz till 200 kHz, although it is not limited on either end by the proposed invention. The typical power ranges from 1-30 mW, although the invention does not impose any range limitations on power.

Some of the tunable filters also comprise of micro concave poly-carbonate lens that forms a cavity without guiding optics or optical collimation, which results in robust filters. As described in U.S. Pat. No. 8,526,472 B2, the Fabry-Perot etalon can be a MEMS based filter, which can have highly resonant frequency deformable membranes, permitting rapid tuning of the filter. A Fabry Perot filter can also be designed and built such that the first mirror of the filter can be a flat mirror and the second (opposite) mirror can be a curved mirror. The optical length of the Fabry Perot interferometer can be modulated electrostatically moving either or both the mirrors.

The next we present the design equations for the Fabry-Perot tunable filter. The refractive index of the medium of the filter is denoted by n, and d is the thickness of the filter. The free-spectral range (FSR) is the band of wavelength where the filter is getting tuned. λₘₐₓ is the maximum wavelength of the tuning band, λₘᵢₙ is the minimum wavelength of the tuning band, λ₀ is the center wavelength of the tuning band.

$$FSR = {λ}_{max} - {λ}_{min} = \frac{{λ}_{0}^{2}}{2 nd}$$

The minimum resolvable wavelength is given by Δλ=FSR/Φ where Φ is the Finesse of the filter

$$Φ = ( \frac{π r}{1 - {r}^{2}} ) .$$

Here r is amplitude (i.e., electric field) reflection coefficient at the either surface of the Fabry-Perot filter.

The filter is typically tuned by either varying the index n or thickness d. For example, the thickness d can be varied using electrostatic actuation. The required variation in d is given by

$$d max - d min = \frac{( {λ}_{max} - {λ}_{min} )}{m} \frac{m}{2 nd}$$

Where m is the order of interference. Typical order can be 1, but higher orders can be used. The d can be varied using resonating action, where a voltage waveform is applied to the surface of a piezoelectric Fabry-Perot cavity. Jonathan Masson, et. al. (2007), provides another example of a tunable filter.

GLV based tunable filter: U.S. Pat. No. 6,342,960 describes a Wavelength Division multiplexing transmitter. Such a transmitter can be configured as a Grating-Light-Valve based tunable filter, which can be used as a tunable filter 316. The GLV based filter proposed in the patent disperses light by a grating. Various wavelengths are incident on a set of GLVs. Each GLV is configured to reflect a specific wavelength perpendicular to the GLV surface. Each of these waves is directed to a lens, which focuses light onto the fiber. Wavelength tuning is achieved by turning on and off various GLVs.

In another embodiment, GLV can be used as a tunable filter itself. Such a filter can be used as a tunable filter 316. A broadband light is incident on the GLV. By manipulating the spacing between the grooves and the depth of the grooves, a specific wavelength can be transmitted or reflected. The spacing and depth of the grooves is altered rapidly to tune the range of wavelength.

The grating equation is given by

mλ₀=n_{g}Γ sin θₘ

λ₀ is the wavelength of interest, and has the principal maximum intensity at angle θₘ. The programmable grating spacing is Γ. For simplicity, if we set the grating order to m=1, and select the first order, and focus the diffracted beam onto a fiber, we can build a tunable filter by varying Γ. A certain amount of blazing would help, although not absolutely necessary. If the blazing angle is B, and the light incident is normal to the grating plane, the reflected light would be at angle −2B radians. The following would be the grating equation, here negative sign means the diffraction order is on the certain side of the grating normal.

mλ₀=−n_{g}Γ sin 2B

For example, if λ₀=800 nm, m=1, B=0.1 radian, the grating refractive index n_{g}=1, ignoring the negative sign, Γ=4026.8 nm. If the GLV is made of very small nm-scale grooves which can be optionally turned OFF or ON; by changing the grating spacing to Γ=4031.8 nm, the principal maximum will shift to 801 nm. By changing the grating spacing to Γ=4027.09 nm, the principal maximum will shift to 800.06 nm. Various mechanisms can be used to change the grating spacing. In one mechanism, the grating grooves are very small, on the order of 0.1 nm or a 0.3 nm. These grooves are turned ON or OFF systematically (i.e., periodically) to change the grating spacing. Altering the spacing, the principal maximum can be shifted. The Rayleigh criterion-separation between of the principal maxima (Width of 2-zeros of the diffraction pattern) is given by (Δλ)ₘᵢₙ=mλ₀N, here N is total number of grooves on the GLV.

Another mechanism to tune wavelength λ₀ (i.e., shift λ₀ for the principal maximum intensity at λ₀) is to modulate the grating refractive index n_{g} (i.e., the refractive index of the grating material compared to the refractive index of its surrounding medium).

Grating based tunable filter: Frank Havermeyer et. al. (2004). describes a grating based tunable filter. Our proposed system could use the proposed filter. The following is the grating equation described in the paper, where λ_{b} is the Bragg phase matching wavelength (the wavelength which gives the brightest intensity of the diffraction pattern), ng is the refractive index of the grating material, Γ is the grating period, θ is the angle of incidence.

λ_{b}=2n_{g}Γ cos θ

The wavelength is tuned by rotating the grating with respect to the incident light and hence changing the angle of incidence. The researchers describe a filter where the grating is mounted by replacing a side of a retroreflector. The retroreflector is rotated to tune the wavelength.

In one embodiment of the instant invention, the tunable filter 316 can be removed from its location in FIG. 3 and placed between the isolator 106 and the coupler arm 104. In another embodiment, the tunable filter 316 can be placed between the light source 102 and the isolator 106. The tunable filter can be a GLV based filter or a Fabry Perot tunable filter or a grating based tunable filter or an acousto-optic tunable filter.

The system described by Ohbayashi et al. (U.S. Pat. No. 7,940,398) requires an optical demultiplexer, multiple detectors, multiple analog to digital converters. In contrast, our system requires only 1 detector, and 1 analog to digital converter (320). Wavelength-division-multiplexing as defined in this invention is a process of separating the input broad-band light into light with narrow-band-wavelengths and outputting them sequentially at different time intervals in a single output fiber. Tunable filter 316 as described in the invention can be a GLV based filter, acousto-optic tunable filter or a tunable interference filter or a tunable Fabry-Perot interference filter. These filters can be tuned electronically with a high speed to perform wavelength-division-multiplexing as defined in this invention.

Ohbayashi et al. (U.S. Pat. No. 7,940,398) are using AWG (Arrayed-Waveguide Grating), which is different than a GLV (Grating-light-valve). The system described by Ohbayashi et al. (U.S. Pat. No. 7,940,398) cannot work with a single detector and a single analog to digital converter. Their system separates out the input broad-band light into light with narrow-band-wavelengths and outputs these simultaneously in multiple fibers. The demultiplexed output light is incident on multiple detectors and the signals are digitized using multiple analog to digital converters.

In one embodiment, we have proposed an interferometric system where the interferometric signal is detected by sampling the signal at a variety of wavelengths (using wavelength-division-multiplexing) using a tunable filter (316). The filter can be a narrow-band filter. The proposed interferometric system comprises of a light source (102) emitting a source beam; a first beam-splitter to split the beam from the light source to generate a reference path and a sample path; a specimen (116) and a means to direct the sample path light to the specimen; a second beam-splitter to combine the light backscattered from the specimen and the reference path light to generate an interference light beam. The proposed system further comprises of the interference beam, which is passed through a tunable filter for multiplexing the interference data of the specimen; a detector (318) coupled to the filter for detecting a multiplexed interference data of the specimen; and a processor (122) for processing the signals received from the detector and analyzing data by means of wavelength division multiplexing as defined earlier in the application. The sample arm light is optionally directed to the specimen (116) using a lateral scanning optical delivery system (324) if multi-dimensional measurements are needed instead of a single dimension. Thus, the system may be a detection system or a ranging system. The system may also be a multi-dimensional metrology system by laterally scanning the beam incident on the specimen by means of an optical system (324). The specimen (116) can be any one of retina, skin, anterior segment of the eye, posterior segment of the eye, gastrointestinal tract, lungs, teeth, blood vessels, subsurface area of semi-conductors, chip manufacturing and sensitive medical equipment.

In a nutshell, we are proposing a method, comprising: emitting a beam from a light source; splitting the beam using a beam splitter from the source arm to a reference arm and a sample arm; the sample arm light backscattering from the specimen; interfering the reference arm light with the light backscattered from the specimen at the detector. The method also comprises measuring the interfered light using a tunable filter at different wavelengths; sensing the beam tuned at various wavelengths using a detector; and processing data sensed using a detector in a processor. Michelson interferometer and Mach-Zehnder interferometer are specific examples of our interferometer.

In a Michelson interferometric system (e.g., 300 in FIG. 3) the first beam-splitter (e.g., 110 in FIG. 3) to split the beam from the light source to generate a reference path and a sample path is the same as the second beam-splitter (e.g., 110 in FIG. 3) to combine the light backscattered from the specimen and the reference path light to generate an interference beam. The beam splitter directs the reference path light to a reference mirror (114 in FIG. 3) and the sample path light onto the specimen. The backscattered sample arm light from the specimen returns to the same beam splitter (110 in FIG. 3); and the reflected light in the reference arm also returns to the same beam splitter (110 in FIG. 3) to generate the interference light beam. The proposed system further comprises of the interference beam entering the detector arm (124), which is passed through the tunable filter (316) for multiplexing the interference data of the specimen. The beam-splitter (110) can optionally be a fiber-optic coupler. If it is a fiber-optic coupler, the PC 126 can be used to match the polarization in sample and reference arms. If 110 is a fiber-optic coupler, the reference arm path can optionally be an optical fiber terminated by a fiber integrated mirror. This fiber integrated mirror could optionally be a birefringent mirror (402).

In a Mach-Zehnder interferometric system (e.g., 1100 in FIG. 11), the reference arm light is reflected by a reference mirror (910) and the reflected light returns to the second beam splitter (716). A third beam splitter (706) is arranged to intersect the sample arm light; and the sample path light further passes through the third beam-splitter to direct the light (beam 719) to the specimen. The light (720) backscattered from the specimen returns to the third beam splitter (light 728); and the backscattered sample arm light (722) is re-reflected through the third beam splitter (706) to the second beam splitter (716). The re-reflected backscattered sample arm light is interfered with the reference arm light to generate the interference light beam (724), which is passed through a tunable filter (316) for multiplexing the interference data of the specimen.

The tunable filter in front of the detector having at least one of a GLV based filter and Fabry Perot filter in Mach-Zehnder Interferometric optical coherence tomography system or Michelson Interferometer apparatus above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

### INDUSTRIAL APPLICATIONS

OCT system and apparatus of this instant application is very useful for diagnosis and management of ophthalmic diseases such as retinal diseases and glaucoma etc. Instant innovative OCT diagnostic system leverages advancements in cross technological platforms. This enables us to supply the global market a low-cost, portable, robust OCT imaging tool, which would be affordable to general physicians, optometrists and other health personnel. Both the Michelson interferometric system & Mach-Zehnder interferometric system presented in this application could be used for the OCT imaging, which includes biological OCT imaging or medical OCT imaging or ophthalmic OCT imaging or corneal OCT imaging or retinal OCT imaging, and the like. According to one more embodiment, the Michelson interferometric system or Mach-Zehnder interferometric system may be a detection system or a ranging system.

What is claimed is:

1. An interferometric system, comprising:
a light source emitting source beam;
a first beam-splitter to split the beam from the light source to generate a reference path and a sample path;
a specimen;
a means to direct the sample path light to the specimen;
a second beam-splitter to combine the light backscattered from the specimen and the reference path light to generate an interference light beam;
the interference light beam is passed through a tunable filter for multiplexing the interference data of the specimen;
a detector coupled to the filter for detecting a multiplexed interference data of the specimen; and
a processor for processing the signals received from the detector and analyzing data by means of wavelength division multiplexing.

2. The interferometric system of claim 1, wherein the interferometric system is a Michelson interferometer, wherein the beam-splitter is a fiber-optic coupler.

3. The interferometric system of claim 2, further comprising:
the first beam-splitter being the same as the second beam-splitter;
the beam splitter directing the reference path light to a reference mirror and the sample path light onto the specimen;
the backscattered sample arm light from the specimen returning to the same beam splitter; and
the reflected light in the reference arm returning to the same beam splitter to generate the interference light beam.

4. The interferometric system of claim 2, wherein the reference arm path is an optical fiber terminated by a fiber integrated mirror.

5. The interferometric system of claim 2, wherein the fiber integrated reference arm mirror is a fiber integrated birefringent mirror.

6. The interferometric system of claim 2, wherein the system is at least one of a detection system or a ranging system.

7. The interferometric system of claim 2, wherein the system is a multi-dimensional metrology system by laterally scanning the beam incident on the specimen by means of an optical system.

8. The interferometric system of claim 2, wherein the specimen is at least one of retina, skin, anterior segment of the eye, gastrointestinal tract, lungs, teeth, blood vessels, subsurface area of semi-conductors, chip manufacturing and sensitive medical equipment.

9. The interferometric system of claim 2, wherein the means to adjust polarization are used in the reference arm to match the polarization in sample arm to achieve optimal signal strength.

10. The interferometric system of claim 2, wherein lateral scanning is achieved by at least one of a micro electro mechanical system or micro-opto-mechanical system.

11. The interferometric system of claim 2, wherein the tunable filter is at least one of an acousto-optic tunable filter or a tunable interference filter or a grating-based filter or grating light valve based filter or a tunable Fabry-Perot interference filter.

12. The interferometric system of claim 2, wherein the system design results in reducing the size of the system to form a compact, portable system using an embedded single integrated circuit.

13. The interferometric system of claim 1, wherein the interferometric system is a Mach-Zehnder interferometer.

14. The interferometric system of claim 13, further comprising:
the reference arm light further being reflected by a reference mirror;
a third beam splitter arranged to intersect the sample arm light;
the sample path light further passing through the third beam-splitter to direct the light to the specimen;
the light backscattered from the specimen returning to the third beam splitter;
the reflected light in the reference arm returning to the second beam splitter;
the backscattered sample arm light is re-reflected through the third beam splitter to the second beam splitter; and
the re-reflected backscattered sample arm light is interfered with the reference arm light.

15. The interferometric system of claim 1, wherein the specimen is at least one of a scattering medium or a biological specimen.

16. The interferometric system of claim 1, where the sample arm light is directed to the specimen using a lateral scanning optical delivery system.

17. The interferometric system of claim 1, wherein the tunable filter is at least one of an acousto-optic tunable filter, a tunable interference filter, a grating-based filter or grating light valve based filter and a tunable Fabry-Perot interference filter.

18. The system of claim 1, wherein the specimen is at least one of retina, skin, anterior segment of the eye, gastrointestinal tract, lungs, teeth, blood vessels, subsurface area of semi-conductors, chip manufacturing and sensitive medical equipment.

19. The interferometric system of claim 1, wherein the system design results in reducing the size of the system to form a compact, portable system using an embedded single integrated circuit.

20. A method, comprising:
emitting a beam from a light source;
splitting the beam using a beam splitter from the source arm to a reference arm and a sample arm;
the sample arm light backscattering from the specimen;
interfering the reference arm light with the light backscattered from the specimen;
measuring the interfered light using a tunable filter at different wavelengths;
sensing the beam tuned at various wavelengths using a detector;
processing data sensed using a detector in a processor.
